(19) United States
(12) Patent Application Publication
(10) Pub. No.: US 2007/0205238 A1
(43) Pub. Date: Sep. 6, 2007

(54) Map Holder

(76) Inventor: Ingemar Gustavsson, Molndal (SE)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 10/599,666

(22) PCT Filed: Apr. 5, 2005
(86) PCT No.: PCT/SE05/00496

§ 371 Date: Oct. 5, 2006

(30) Foreign Application Priority Data
Apr. 6, 2004 (SE) 0400920-5

(51) Int. Cl. B62J 11/00

(52) U.S. Cl. 224/277

(57) ABSTRACT

Existing invention directs to map holder (1; 101) considered to be used in activities with vehicles, comprising a map holder party (7: 107) and a vehicle fixation (3; 103), at which mentioned map holder party (7; 107) include a surface spread support element (9; 109) that is arranged to be fixed on the vehicle with mentioned vehicle fixation (3; 103), at which mentioned support element (9; 109) consists a support for a turn able take up of a mutually surface spread map carrying element (11; 111).

### FIELD OF THE INVENTION

Existing invention is related to a map holder considered to be used at activities with vehicles at which the map holder is containing a map holding party and a fixation to the vehicle.

### BACKGROUND OF THE INVENTION

During activities with vehicles on land or at sea, for example bicycling or kayak paddling, there are frequent a need to be able to orient your self. The most common way to orient your self today is by using a map. Such a map is usually contained in a sealed cover, as a plastic pocket, to stand water, weather and wind.

To be able to keep the map during exercise of activities with vehicles it is today the most common existing method that the user caries the map folded in a pocket. This gives that the user takes out the map and unfolds it each time a need of orienteering is at hand. Usually the user first needs to find the earlier position when the map was used last time, find the new position and after that the direction to the next goal. After this the map is folded and placed back in to the pocket before the journey is continued. Limited orienteering possibilities and risk for orienteering mistakes can limit the positive experience from the performed activity.

Further is the above described way of handling a map when using a vehicle experienced as time consuming and difficult for the user. Frequently the user must stop the vehicle to get the hands free to take out the new direction for the continuation of the journey. This can especially cause difficulties when conducting activities as mountain biking or multi sport, by professional or elite sports amateurs, where increased time consumption for the orienteering moment will influence negatively on the overall performance.

Within the known technology there are map holders intended to be fixed to the vehicle, for example a bicycle. These map holders are by many seen as bulky and often standing in the way for the view in critical moments when performing the activity, which makes the usage limited. Within the known technology there are as well map holders intended to be hanged around the neck. However are these map holders who are intended to be hanged around the neck usually making trouble for the user as they can flutter in the wind of speed, and when they usually require at least to be held with one hand at usage.

DE3902824 describes a map holder who is intended to be fixated to the handlebar of a bicycle. The descried map holder is shaped as a box with a transparent lid, which allows the lid to be opened and closed. The map is positioned inside the box under the transparent lid when used. Further the box is possible to rotate 360° in the plane of the box around an axle.

The according to DE3902824 described map holder has a essential bulky build and can due to this cause that the sight is considerable hidden for the user, which is particularly critical in certain situations with activities with vehicles in terrain, as mountain biking. Further has the described map holder a shape and position on the bike that makes it possible for the user to injure him self at a fall or sudden halt. A map holder as what is described in DE3902824 brings that the design usually becomes heavy and vulnerable for loads and hits. A heavy design brings frequently that the map holder vibrates during movement, which can bring difficulties for the user to read the in the map holder placed map.

Accordingly exists a need of a improved map holder who allows a suitable strength, an ergonomic design and a cost efficient production.

### SUMMARY OF THE INVENTION

One purpose with the here existing map holder is to supply a robust map holder.

One other purpose with the existing invention is to supply an ergonomic map holder.

An additional purpose with the existing invention is tu supply a map holder who is cost efficient and easy to produce.

The above mentioned purposes and other purposes that will appear in the following description are achieved with a map holder described in the attached patent claims.

According to one aspect of the here existing invention brings about a map holder concerned for use in activities with vehicles, including a map holder party and on vehicle fixation, where the mentioned map holder party includes one surface spread support element that is arranged to be fastened to the vehicle through the mentioned vehicle fixation, at which mentioned support element works as a support for a rotate able support of a similarly surface spread map carrying element.

Consequently a map holder, who is easy to operate to different required map picture positions, is acquired. Further is brought about a possibility to supply a map holder which consists of a few parts that can be arranged with good strength and good ergonomic.

According to one possible design there is a guiding element arranged to keep the map picture carrying element turn able with the support element. Further the mentioned guide is preferable positioned in connection to the map holder sections periphery. Such guiding allows for support elements and the map holder section to be turned relatively to each other without locking turning elements that often becomes the weak spot in a turn able design of a map holder. Further supplies mentioned guiding an easy handling of the map holder through a few grips at placing and removal of a map picture.

According to one design of the map holder is the mentioned guide arranged as a part of the support element, which guiding is arranged to run along at least parts of the periphery of the map carrying element.

According to an additional alternative design the mentioned guiding is arranged as at least one separate element gripping around at least parts of the periphery of the support element and at least of parts of the periphery of the map carrying element.

It is perceived that the above mentioned guiding also can be achieved in many alternative ways where the guiding not is arranged to run along any of the elements periphery. For example the guiding can be supplied as at least one runner who is arranged as at least one runner that is arranged on one of the surface spread elements, which runner is taken up in guiding tracks in the opposite surface spread element.

These alternative arrangements of the guiding allows for a range of different designs of the map holder. Common for all these are that the turn ability between the support element and the map picture carrying clement is brought about by that the guide takes up at least one of the both elements running. In one presented design the mentioned guiding is supplied as at least three running organs positioned at the periphery. Especially presented is to design these running organs as grabbing hooks.

According to an alternative design it is also possible to arrange mentioned guiding as a peripheral seal. With a peripheral seal it is possible to bring about a sealed volume between the support element and the map carrying element to minimize he risk for moisture to enter in between these elements.

According to a special presented design the support element and the map carrying element has a circular shape. By designing the two elements with a circular allows a possibility to arrange them turn able relatively to each other by at least one in the close range of the map holder sections periphery arranged guide as above. Consequently a possibility is created to supply a turn able map holder using small means. Further the round shape is ergonomic favorable at for example a accident or a sudden halt of the vehicle.

Preferable is the map holding element concerned to carry a map picture between the the support element and the map holding element. According to one design the map carrying element is furnished with carrying organs to bring the map picture in its turning movement on the support element. According to a specially preferred design the mentioned guiding are the carrying organs. It is perceived that it is possible to arrange these carrying organs in many different ways. For example he carrying organs can consist of clamps, to the map picture adhesive surfaces etc. Further shall be noted that the map carrying element can carry the map picture in many ways. For example the map picture can be arranged at the side of map carrying element directed away from the support element, the map picture carrying element can in it self consist the map picture or the map picture can be arranged between mentioned elements.

Preferable is a seal plate and the map picture carrying element reciprocally sealed to each other. Such a sealing is particular preferred as a map picture is arranged between mentioned seal plate and the map picture carrying element, at which the map picture is protected against water and moisture.

According to one design the above mentioned vehicle fixation place able with one for the vehicle shaped vehicle adapter. According to one special preferred design the mentioned vehicle fixation is fixated to the vehicle with a elastic cord. Through one to the vehicle in shape adapted vehicle adapter requires a stable fixation of the map holder, which gives small vibrations at usage. The fixation with the elastic sweep allows that the map holder easily can be attached and detached from the vehicle.

According to a special presented design the map holder is concerned to be arranged on a bike.

### BRIEF DESCRIPTION OF THE DRAWINGS

In the following presented designs will be described in further detail with direction to attached, exemplifying drawings, on which:

FIG. 1 schematic in perspective shows a map holder according to existing invention;

FIG. 2 in a exploded view in perspective shows the map holder according to FIG. 1;

FIG. 3 in an exploded view in perspective shows an alternative design of the map holder according to the invention;

FIG. 4 in perspective shows how a map party of he map holder according to FIG. 1 is brought apart;

FIG. 5a-5b shows additional alternative designs of map holder according to the invention.

### DETAILED DESCRIPTION OF THE INVENTION

The invention will now in exemplifying purpose be described more in detail with the help of design samples and directed to the attached drawings.

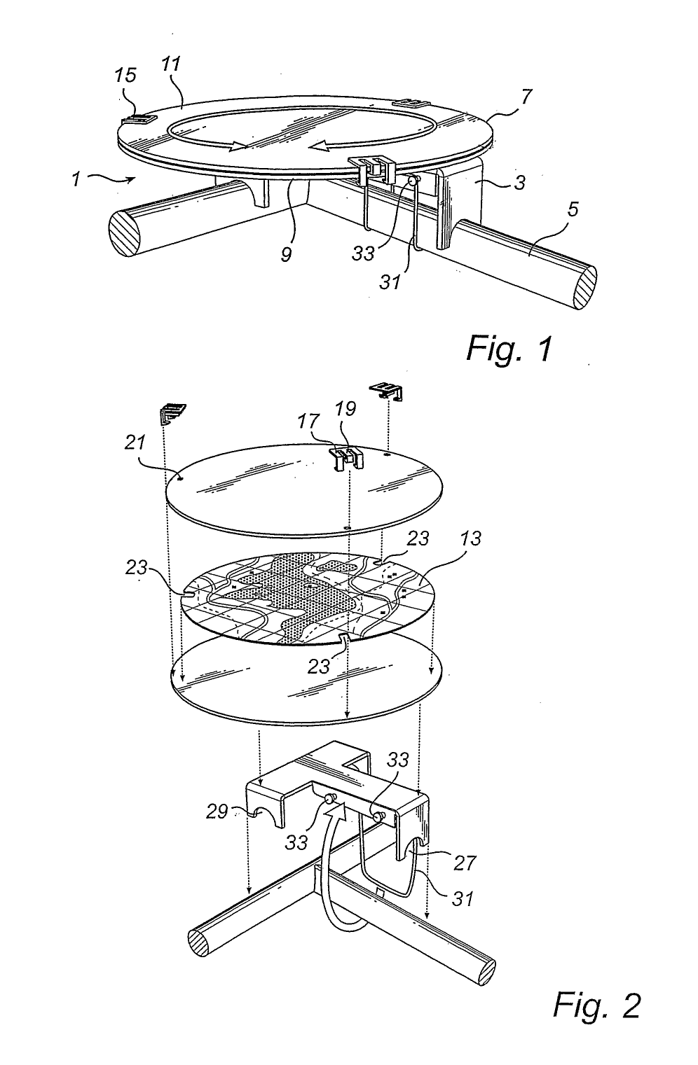

The map holder 1 who is shown in FIGS. 1-2 comprising of a fixation 3 that consists of a vehicle adapter with the purpose to be fixated on for example a bicycle handle bar and stem 5. Mentioned fixation 3 is fixated to a map holder party 7 which consists of a surface spread support element 9, which in the shown design consists of a circular flat element, and a like vise circular surface spread map carrying element 11, which is turn able taken up by the mentioned support element 9.

The support element 9 and the map picture carrying element 11 are in the presented shape designed as circular plates. The map carrying element 11 and the support element 9 are preferable designed in a transparent plastic material as polycarbonate.

Further it is the map carrying element 11 according to FIGS. 1-2 carried by support element 9 and kept turn able with the map picture carrying with this by one on the map carrying element 11 arranged guiding. According to a presented design the mentioned guiding is arranged as three running organs 15 that are positioned at the periphery of the map holing party 7. The three running organs 15 according to the in picture 1-2 shown design are designed as clippings, which contains two gripper armes 17 that embraces the periphery edge of the support element 9 and the map picture carrying lement 11. Further is each of the shown clippings 15 supplied with a fixation arm 19 that is positioned between the two embracing arms 17 which embraces the periphery edge of support element 11. Further is each of the shown clippings 15 furnished with an fixation arm 19 that is positioned between the two gripper arms 17, which fixation arm 19 is snap hook locking in the outtake 21 in the map carrying element 11 and embraces its periphery to fixate the clipping 15 to the map carrying element 11. The fixation arm 19 is further preferable furnished with a fixation party, not shown, that is aimed to keep the map picture 13 on the map picture carrying element 11 at the dismantling of this from support element 9.

Mentioned guiding 15 that keeps the map carrying element 11 together with the support element 9, allows that the map carrying element 11 is turn able relative to the to support element 9. Mentioned turn ability is acquired by the attaching clippings 15 that are fixated on the map picture carrying element 11 are arranged to run on the periphery of the support element 9.

In designs according to FIGS. 1-2 is a map picture 13 arranged between support element 9 and the map picture carrying element 11, which is transparent so that is possible visually to access the map picture 13. The map picture 13 is in one presented design arranged as a map sheet, which preferably is protected by a sealed plastic foil.

According to one design the turning movement of the map picture 13 is brought about by that it is carried by the map picture carrying element 11 when this is turned relative to the support element 9. In the according to the FIGS. 1-2 shown design of the map holder 1 is the map picture 13 arranged to be brought by the map picture carrying element 11 by that parts of the clip 15 fixation arm 19, who is positioned between the map picture carrying element 11 and support element 9 is taken up in corresponding outtakes 23 on the map picture 13 at which the map picture 13 is forced to be brought in a turning of the map carrying element 11. In this way it is possible to turn the map carrying picture 13, for example to be in the vehicles line of movement, by turning the map carrying picture 11, which will allow a good readability of the map picture for the user.

The according to design in FIG. 1-2 shown fixation 3 of the map holder 1, in shape of a vehicle adapter, is shaped to rest against a bicycle handle bar and stem 5. Vehicle adapter 3 is furnished with one stem outtake 27 that is concerned to rest against the stem ind two handle bar outtakes 29 that are concerned to to rest against the handle bar, at which a three point contact is achieved between the between the vehicle adapter 3 and the bicycle.

At fastening the of the vehicle adapter 3 on for example a bicycle, a elastic cord 31 is used that is fixated at one side of the vehicle adapter 3 relatively the stem 5. When the vehicle adapter 3 is fixated to the bike, tensions and moves the rubber cord 31 around the stem 5 on the side that is against the vehicle adapter 3 and there after the rubber cord 31 is fixated on the vehicle adapters 5 opposite side with a hook element 33. Accordingly a easy fixation and loosening of the vehicle adapter 3. It is perceived by a professional that the fixation of the rubber cord can be designed in many ways, as hooks, clamps, screws, holes, ribs etc. It is also perceived that the vehicle adapters 3 shape that is concerned to take up and rest against an opposite complementary shape on the vehicle can be designed in many ways and is first of all chosen with respect to the shape of the vehicle where the vehicle adapter 3 will be positioned. Further it shall be noted that the vehicle adapter 3 either can be designed as a separate element, on to which the support elements 9 are fixated, or in one piece with the support element 9. In the case of that the support element 9 is fixated to the vehicle adapter 3 as a separate part, can this fixation allow releasing and reassembly of the support element 9 by a simple grip. The vehicle adapter 3 is preferably designed in a polymeric material or metallic.

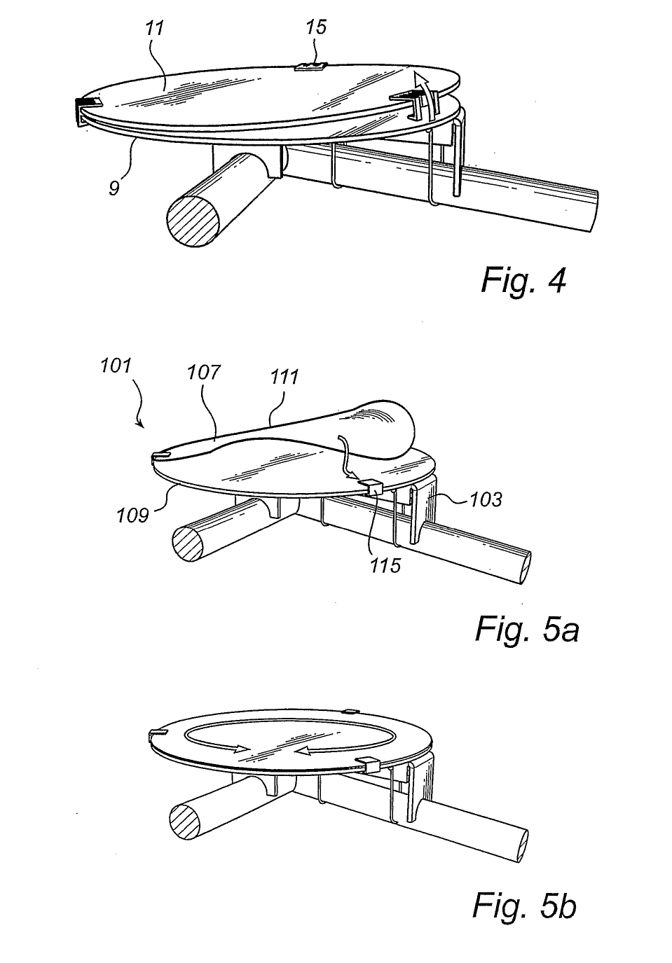

When a map picture 13 is arranged between the support element 9 and the map carrying element 11, the later is released from the support element 9 with a simple grip. A release of the map picture carrying element 11 from the support element 9, according to the FIGS. 1-2 showing the design, the map carrying element 11 is bent so that at least parts of its guiding is 15 is moved out of position with support element 9, shown in FIG. 4. As soon as the as the guiding 15 is taken out of locking position with support element 9 the map carrying element is the map carrying element 11 is possible to be removed. There after a map picture 13 in shape of for example a map sheet on the map picture carrying element 11 by that the map picture 13 outtakes are attached to the clippings 15 fixation arms 19 according to the description above. As soon as the map sheet 13 is attached to the map carrying element 11 it can again attached with support element 9. Consequently this joining is brought about by that parts of the guiding 15 is pushed in to grip with the support element 9, at which the guiding 15 by bending the map picture carrying element 11 finally can be moved to fall attachment with support element 9. It is also possible to completely or partly achieve the reassembly and assembly of the map carrying element 11 and support element 9 by that the guiding 15 is deformed. It is perceived by the professional that it is possible to arrange the map carrying party 7 with loose guiding parts 15, which are removed to allow disassembly of the map carrying element 11 and he support element 9 and rejoined at assembly of mentioned element 9, 11.

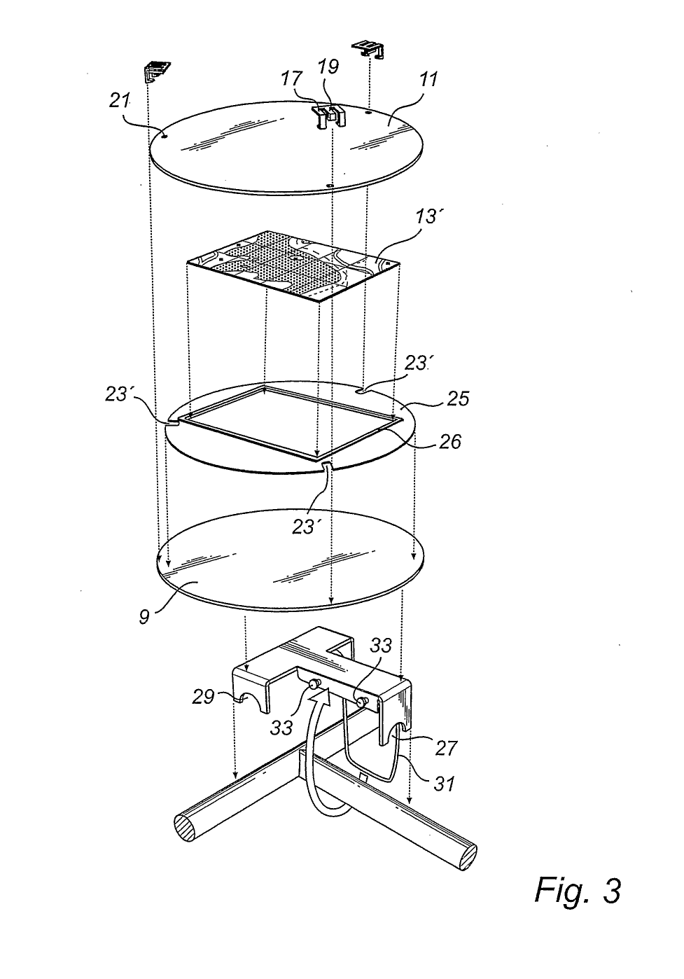

In FIG. 3 it is shown an alternative design of the map holder 1 according to the invention. This design is in many considerations similar with the design according to FIGS. 1-2, why the only differences between mentioned designs are described below.

The design according to FIG. 3 is arranged with a surface spread sealing plate 25 that is arranged between the map carrying element 11 and support element 9. Further is the sealing plate 25 provided with a sealing element 26 that is due to seal in contact against the map picture carrying element 11 in the map holders 1 assembled position. The sealed space between sealing plate 25 and the map carrying element 11 that is achieved is in purpose to contain a map picture 13′, which accordingly is protected from moisture and damp. Further is the sealing plate 25 furnished with outtakes 23′ that are concerned to by fitting shape take up the clippings 15 gripping arms 19, as the seal plate 25 is allowed to be brought with at a turning of the map carrying element 11 relatively support element 9. Sealing element 26 on the sealing plate 25 allows that the map is brought along with a turning of the map carrying element 11 and accordingly the seal plate 25.

It is perceived that the sealing plate can be designed in many ways. For example the sealing element 26 on the seal plate 25 is arranged as one in a track with a fitting shape taken up fillet or as an alternative as one on the seal plate 25 attached fillet. In an alternative design the seal plate 25 and the seal element 26 is shaped in one piece and of the same material. In an additional alternative design can the seal plate 25 and the seal element 26 is supplied by over molding. It shall be noted that it also possible to arrange the seal element 26 on the map carrying element 11.

In FIGS. 5a-5b is shown an alternative design of a map holder 101 according to the invention. In this design is the support element 109, which in FIGS. 5a-5b is attached on a vehicle adapter 103 of similar kind as the design according to FIGS. 1-4, designed with a guiding 115 that is aimed to take up e map carrying element 111 turn able. The map picture carrying element 111 is designed in this design of a map sheet, which preferable is protective sealed with tight cover, such as a plastic sheet or similar.

Support element 109 guiding 115 is arranged to keep the map sheet 111 to support element 109 and to guide the map sheets periphery edge, at which the map is allowed to be turned relative the support element 109 to allow positioning of the map picture 111 in whished direction for reading. In the shown design according to FIGS. 5a-5b is the guiding 115 designed as three pieces in connection to support element 109 periphery arranged hooks. It is perceived that these guiding 115 can be arranged in many different ways to allow the above attachment and turn ability.

Map sheet 111, which preferable is flexible, is arranged according to the design shown in FIG. 5a-5b on the support element through that the map sheet 111 is bent and positioned in under mentioned guiding 115, shown in FIG. 5a. Alternatively can the map sheet 111 be arranged on the support element first, and later the guiding 115 is attached to the support element 109 to keep the map sheet 111 and keep the same turn able.

It is perceived by the professional that it for all designs are possible to design the guiding 15; 115 to turn able keep support element 9; 109 and the map picture carrying element 11; 111 in many different ways. For example the guiding 15; 115 stretches essentially along the whole periphery of the map holder party 7; 107 or consists of one or more parts that that are spread in connection to the map holder parties 7; 107 periphery. Further it is possible to design the guiding 15; 115 in one piece with some of the in the map holder parties 7; 107 ingoing surface element 9, 11; 109, 111. However it is also possible to design the guiding 15; 115 as separate parts, which possible can be attached to some part of the map holder party 7; 107 or be elements that can be snapped to embrace the map holder parties support element 9; 109 and map picture carrying element 11; 111. In an additional alternative design it is possible to arrange the guiding 15; 115 as a seal, which seals the volume between support element 9; 109 and the map carrying element 11; 111. In an alternative design, where the mentioned seal consists of one piece of either support element 9: 109 or the map carrying element 11; 111, can the seal be processed by over molding.

It is perceived by the professional that the map picture 13 can be arranged in many ways. For example the map picture 13 consist as a part of the map carrying element 11, as a map picture that is sealed in the map picture carrying element 11. It is perceived by the professional that the with-bringing organs, which are arranged to carry the map picture 13 when the map carrying element 11 is turned, can be arranged in many ways. For example can these with bringing organs consist of guiding that locks the map picture against turning relative the map picture carrying element 11 or as clamps that clamp the map picture to the map picture carrying element 11. According to an additional alternative design is the map picture 13 attached on the map carrying element 11 with for example Velcro, self adhesive surface or double sided adhesive tape.

It shall be noted that it is possible to arrange the map holder 1; 101 according to the invention to carry one or several map pictures at the same occasion. I shall as well be noted that the map holder according to the invention can be used for several vehicles and purposes, such as bicycling, ski-do, motorbike, dog sledge, kayak, sail dinghy, horse riding etc.

1-17. (canceled)

18. A map holder for removably attaching a map to a part of a vehicle, said map holder comprising:
a map holder assembly having a support element, a map carrying element, and at least one guide, said map carrying element being rotatably and removably attachable to a top section of said support element, said guide being attachable to said map carrying element and said support element and positionable over the peripheral edge of said support element and said map carrying element, said map carrying element and said support element being adapted to receive a map therebetween; and
a vehicle fixation assembly attachable to a bottom section of said support element, said vehicle fixation assembly being attachable to a part of a vehicle.

19. The map holder according to claim 18, wherein said guide is a peripheral seal.

20. The map holder according to claim 18, wherein said guide comprising at least one gripping arm and a fixation arm, said griping arm being adapted to run along the peripheral edge of said support element, said fixation arm extends out from said gripping arm and is attachable to said map carrying element.

21. The map holder according to claim 20, wherein said gripping arm is a pair of gripping arms, and said fixation arm is a hook positioned between said gripping arms, said griping arms being adapted to run along the peripheral edge of said support element, said hook being attachable to an outtake defined in said map carrying element.

22. The map holder according to claim 21, wherein said map holder assembly comprising of at least three guides.

23. The map holder according to claim 18, wherein said support element and said map carrying element are circular in shape and transparent.

24. The map holder according to claim 18, wherein said vehicle fixation assembly further comprising at least one vehicle adapter, an elastic cord, and at least one hook, said vehicle adapter being removably attachable to said part of said vehicle, said elastic cord being adapted to be wrapped around said part of said vehicle and then removably secured to said hook thereby securing said vehicle fixation assembly to said part of said vehicle.

25. The map holder according to claim 24, wherein said vehicle adapter defines an outtake that corresponds to the shape of said part of said vehicle.

26. The map holder according to claim 18, wherein said map carrying element further comprising at least one map carrying organ which corresponds to an outtake defined in the periphery of said map.

27. The map holder according to claim 18 further comprising a map sealing plate positionable between said support element and said map carrying element, said map sealing plate being adapted to seal said map to said map carrying element.

28. The map holder according to claim 27, wherein said map sealing plate comprising a sealing element adapted to seal in contact against said map carrying element and contain said map.

29. The map holder according to claim 28, wherein said map sealing plate further comprising at least one outtake defined in the peripheral edge of said map sealing plate and which corresponds to said guide.

30. The map holder according to claim 18, wherein said guide is a part of said map carrying element and arranged to run along at least a part of the periphery of said support element.

31. The map holder according to claim 18, wherein said guide is arranged as a part of said support element and arranged to run a long at least one part of the periphery of said map carrying element.

32. A map holder for removably attaching a map to a part of a vehicle, said map holder comprising:
a map holder assembly having a support element, a map carrying element, and at least one guide, said guide being fixated to said support elements periphery, said map carrying element being rotatably and removably attachable to a top section of said support element; and
a vehicle fixation assembly attachable to a bottom section of said support element, said vehicle fixation assembly being attachable to a part of a vehicle.

33. The map holder according to claim 32, wherein said guide is peripheral seal.

34. The map holder according to claim 32, wherein said map holder assembly comprising of at least three guides.

35. The map holder according to claim 32, wherein said support element and said map carrying element are circular or semi-circular in shape.

36. The map holder according to claim 32, wherein said vehicle fixation assembly further comprising at least one vehicle adapter, at least one elastic cord, and at least one hook, said vehicle adapter being removably attachable to said part of said vehicle, said elastic cord being adapted to be wrapped around said part of said vehicle and then removably secured to said hook thereby securing said vehicle fixation assembly to said part of said vehicle.

37. The map holder according to claim 32, wherein said vehicle adapter defines an outtake that corresponds to the shape of said part of said vehicle.
